(19) United States
(12) Patent Application Publication
(10) Pub. No.: US 2026/0210078 A1
(43) Pub. Date: Jul. 23, 2026

(54) WORK MACHINE, BRAKING SYSTEM FOR WORK MACHINE, AND CONTROL METHOD FOR WORK MACHINE

(71) Applicant: KOMATSU LTD., Minato-ku, Tokyo (JP)

(72) Inventor: Akira TAKENO, Minato-ku, Tokyo (JP)

(73) Assignee: KOMATSU LTD., Minato-ku, Tokyo (JP)

(21) Appl. No.: 19/140,007

(22) PCT Filed: Dec. 12, 2023
(86) PCT No.: PCT/JP2023/044381

§ 371 Date: Jun. 17, 2025

(30) Foreign Application Priority Data
Dec. 27, 2022 (JP) 2022-210155

(51) Int. Cl. E02F 9/20; B60T 7/22; E02F 9/08; E02F 9/22; E02F 9/26

(52) U.S. Cl. CPC E02F 9/2033; B60T 7/22; E02F 9/0841; E02F 9/262; E02F 9/265; B60T 2210/32; E02F 9/2203; E02F 9/2253; E02F 9/2296

(57) ABSTRACT

Automatic braking control for automatically braking traveling is performed. A controller restricts a lifting operation of a work implement during the execution of the automatic braking control.

### TECHNICAL FIELD

The present disclosure relates to a work machine, a braking system for a work machine, and a control method for a work machine.

### BACKGROUND ART

Japanese Utility Model Registration No. 3219005 (Patent Document 1) discloses collision prevention control for detecting a rear obstacle and automatically stopping traveling in a wheel loader which is an example of a work machine.

In the wheel loader illustrated in Patent Document 1, an area from the wheel loader to the object is divided into three areas, that is, a first area, a second area, and a third area in order of increasing distance from the object. In the collision prevention control, when an obstacle is present in the first area having the shortest distance from the wheel loader, the brake is automatically operated to stop the traveling of the vehicle.

### CITATION LIST

### Patent Literature

Patent Document 1: Japanese Utility Model Registration No. 3219005

### SUMMARY OF INVENTION

### Technical Problem

However, during work at a construction site, the work machine may be in an unstable posture. In such an unstable posture, when sudden braking is performed by the collision prevention control described in Patent Document 1, the posture of the work machine becomes more unstable.

An object of the present disclosure is to provide a work machine, a braking system for a work machine, and a control method for a work machine capable of maintaining a stable state even when braking by automatic braking control is performed.

### Solution to Problem

Each of a work machine and a braking system for the work machine according to one aspect of the present disclosure performs automatic braking control for automatically braking traveling. Each of a work machine and a braking system for a work machine according to one aspect of the present disclosure includes a traveling body, a work implement disposed on the traveling body, and a controller configured to restrict a lifting operation of the work implement during execution of the automatic braking control.

Each of a work machine and a braking system for the work machine according to another aspect of the present disclosure performs automatic braking control for automatically braking traveling. Each of a work machine and a braking system for a work machine according to another aspect of the present disclosure includes a front frame, a rear frame swingably coupled to the front frame, and a controller configured to restrict an operation of increasing a swing angle of the rear frame with respect to the front frame during execution of the automatic braking control.

In one control method for a work machine according to one aspect of the present disclosure, the work machine includes a traveling body and a work implement disposed on the traveling body, and automatic braking control for automatically braking traveling is performed. A control method for a work machine according to one aspect of the present disclosure includes a step of starting execution of automatic braking control, and a step of restricting a lifting operation of a work implement during execution of the automatic braking control.

In a control method for a work machine according to another aspect of the present disclosure, the work machine includes a front frame and a rear frame swingably coupled to the front frame, and automatic braking control for automatically braking traveling is performed. A control method for a work machine according to another aspect of the present disclosure includes a step of starting execution of automatic braking control, and a step of restricting an operation of increasing a swing angle of a rear frame with respect to a front frame during execution of the automatic braking control.

### Advantageous Effects of Invention

According to the present disclosure, it is possible to realize a work machine, a braking system for a work machine, and a control method for a work machine capable of maintaining a stable state even when braking by automatic braking control is performed.

### BRIEF DESCRIPTION OF DRAWINGS

FIG. 1 is a side view illustrating a configuration of a wheel loader according to an embodiment of the present disclosure.

FIG. 2 is a block diagram illustrating a braking system for the wheel loader of FIG. 1.

FIG. 3 is a hydraulic circuit diagram illustrating a configuration of the braking device of FIG. 2.

FIG. 4 is a block diagram illustrating a configuration of an operation device, a detection device, and a controller in FIG. 2.

FIG. 5 is a side view for explaining a height H of the work implement in the wheel loader.

FIG. 6 is a top view for explaining a swing angle θ in the wheel loader.

FIG. 7 is a first flowchart illustrating a control method for a wheel loader according to an embodiment of the present disclosure.

FIG. 8 is a second flowchart illustrating the control method for the wheel loader according to the embodiment of the present disclosure.

### DESCRIPTION OF EMBODIMENTS

Hereinafter, embodiments of the present disclosure will be described with reference to the drawings.

In the specification and the drawings, the same components or corresponding components are denoted by the same reference numerals, and redundant description will not be repeated. In the drawings, the configuration may be omitted or simplified for convenience of description. In addition, at least some of the embodiments and the modifications may be arbitrarily combined with each other.

### Configuration of Wheel Loader 100

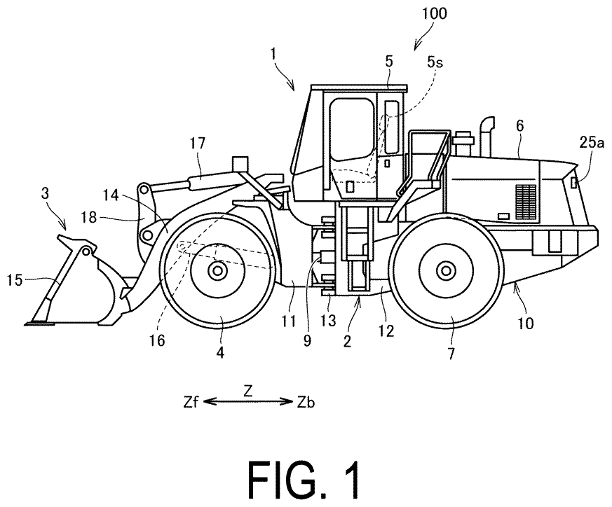

A configuration of a wheel loader 100 in the present embodiment will be described with reference to FIG. 1.

FIG. 1 is a side view illustrating a configuration of the wheel loader 100 (an example of a work machine) according to an embodiment of the present disclosure. As illustrated in FIG. 1, the wheel loader 100 in the present embodiment has a vehicle body 1 and an object sensor 25a. The vehicle body 1 includes a traveling body 2 and a work implement 3. The work implement 3 is disposed on the traveling body 2. The traveling body 2 includes a vehicle body frame 10, a pair of front tires 4, a cab 5, an engine room 6, a pair of rear tires 7, and a steering cylinder 9. The wheel loader 100 performs earth and sand loading work or the like using the work implement 3.

In the following description, “front”, “rear”, “right”, “left”, “up”, and “down” indicate directions based on a state in which an operator seated on an operator seat 5s in cab 5 looks forward. In FIG. 1, the frontward-rearward direction is indicated by Z, the frontward direction is indicated by Zf, and the rearward direction is indicated by Zb.

The vehicle body frame 10 is of a so-called articulated (swinging) type, and includes a front frame 11, a rear frame 12, and a coupling shaft portion 13. The front frame 11 is disposed in the frontward direction Zf of the rear frame 12. The coupling shaft portion 13 is provided at the center of the vehicle body frame 10 in the left-right direction (vehicle width direction), and swingably couples the front frame 11 and the rear frame 12 to each other. The pair of front tires 4 are attached to the left and right of the front frame 11. The pair of rear tires 7 are attached to the left and right of the rear frame 12.

The work implement 3 is driven by hydraulic oil from a work implement pump (not illustrated). The work implement 3 includes a boom 14, a bucket 15, a lift cylinder 16, a bucket cylinder 17, and a bell crank 18. The boom 14 is attached to front frame 11. The bucket 15 is attached to a distal end of the boom 14.

The lift cylinder 16 and the bucket cylinder 17 are hydraulic cylinders. One end of the lift cylinder 16 is attached to the front frame 11, and the other end of the lift cylinder 16 is attached to the boom 14. The boom 14 swings up and down by extension and contraction of the lift cylinder 16. One end of the bucket cylinder 17 is attached to the front frame 11, and the other end of the bucket cylinder 17 is attached to the bucket 15 via a bell crank 18. As the bucket cylinder 17 extends and contracts, the bucket 15 swings up and down.

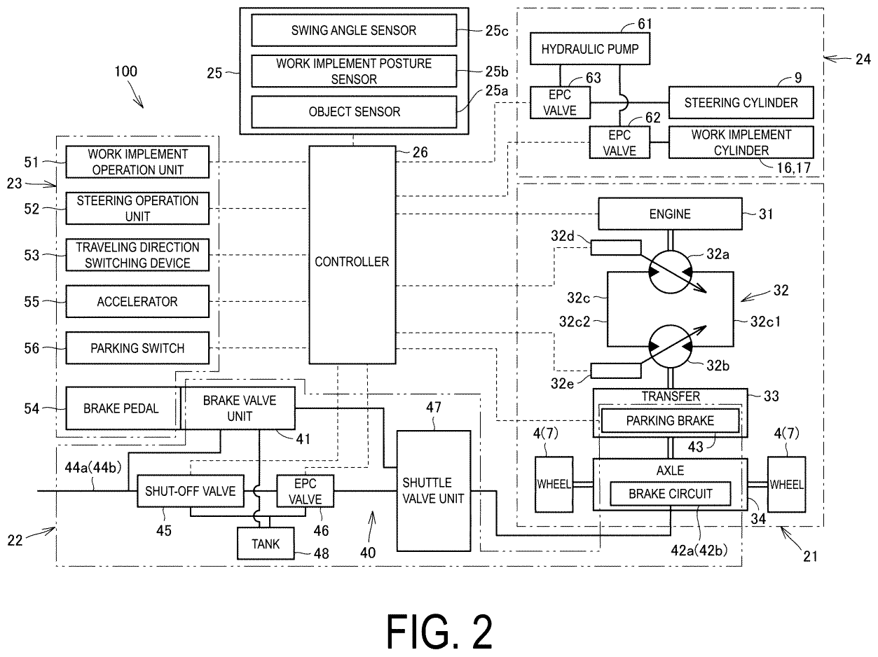

The cab 5 is placed on the rear frame 12. Inside the cab 5, the operator seat 5s for an operator to sit on, a steering wheel for steering operation, a lever for operating the work implement 3, various switches, a display, and the like are disposed. The engine room 6 is disposed on the rear frame 12 in the rearward direction Zb of the cab 5, and houses an engine 31 (FIG. 2).

### Braking System for Wheel Loader 100

Next, a braking system for the wheel loader 100 in the present embodiment will be described with reference to FIGS. 2 to 4.

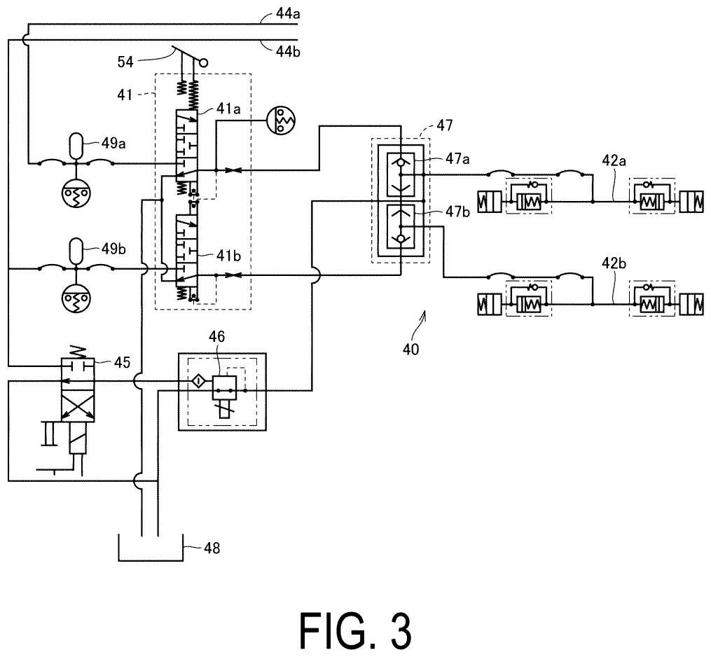

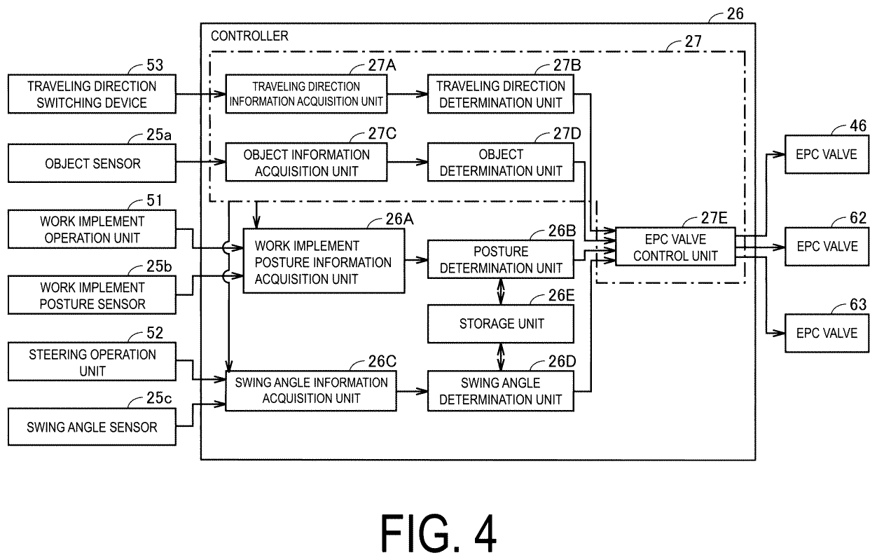

FIG. 2 is a block diagram illustrating the braking system for the wheel loader of FIG. 1. FIG. 3 is a hydraulic circuit diagram illustrating a configuration of the braking device of FIG. 2. FIG. 4 is a block diagram illustrating a configuration of an operation device, a detection device, and a controller in FIG. 2.

As illustrated in FIG. 2, the braking system for the wheel loader 100 includes a drive device 21, a braking device 22, an operation device 23, an operation unit 24, a detection device 25, and a controller 26.

The drive device 21 drives the wheel loader 100. The braking device 22 brakes the wheel loader 100. The operation device 23 is operated by an operator. The operation unit 24 operates each of the work implement 3 and the steering. The detection device 25 detects a braking factor (an obstacle, a cliff, or the like) around the vehicle body 1, a work implement posture, a swing angle, and the like. The controller 26 operates the drive device 21, the braking device 22, and the operation unit 24 based on the operation by the operator on the operation device 23 and the detection by the detection device 25.

### Drive Device 21

As illustrated in FIG. 2, the drive device 21 includes an engine 31, a HST 32, a transfer 33, an axle 34, the front tire 4, and the rear tire 7.

The engine 31 is, for example, a diesel engine, and a driving force generated by the engine 31 drives a pump 32a of a HST (Hydro Static Transmission) 32.

The HST 32 includes the pump 32a, a motor 32b, and a hydraulic circuit 32c. The pump 32a is, for example, a swash plate type variable displacement pump, and an angle of a swash plate can be changed by a solenoid 32d. The pump 32a is driven by the engine 31 to discharge the hydraulic oil. The discharged hydraulic oil is sent to the motor 32c through the hydraulic circuit 32b. The motor 32b is, for example, a swash plate type pump, and an angle of a swash plate can be changed by a solenoid 32e.

The hydraulic circuit 32c connects the pump 32a and the motor 32b. The hydraulic circuit 32c includes a first drive circuit 32c1 and a second drive circuit 32c2. When the hydraulic oil is supplied from the pump 32a to the motor 32b through the first drive circuit 32c1, the motor 32b is driven in one direction (for example, the forward direction). When the hydraulic oil is supplied from the pump 32a to the motor 32b through the second drive circuit 32c2, the motor 32b is driven in the other direction (for example, the reverse direction). The discharge direction of the hydraulic oil to the first drive circuit 32c1 or the second drive circuit 32c2 can be changed by the solenoid 32d.

The transfer 33 distributes the output from the engine 31 to the front and rear axles 34.

The pair of front tires 4 are connected to the front axle 34, and are rotated by the distributed output from the engine 31. The pair of rear tires 7 are connected to the rear axle 34, and are rotated by the distributed output from the engine 31.

### Braking Device 22

The braking device 22 includes a braking unit 40 and a shut-off valve 45. The braking unit 40 performs braking of the vehicle body 1 based on the operation of a brake pedal 54, and performs automatic braking control of the vehicle body 1 based on a command from the controller 26. The shut-off valve 45 brings the braking unit 40 into a state in which the braking force by the automatic braking control can be exerted or cannot be exerted.

The braking unit 40 includes a brake valve unit 41, brake circuits 42a and 42b (an example of a service brake), a parking brake 43, hydraulic oil supply passages 44a and 44b, an EPC (Electric Proportional Valve) 46, a shuttle valve unit 47, and a tank 48.

Accumulators, pumps, and the like are connected to the hydraulic oil supply passages 44a and 44b, and the hydraulic oil is supplied.

As illustrated in FIG. 3, the brake valve unit 41 is operated by a brake pedal 54 to be described later. The brake valve unit 41 includes a rear brake valve 41a and a front brake valve 41b. Each of the rear brake valve 41a and the front brake valve 41b is a three position directional control valve having three ports.

The first port of the rear brake valve 41a is connected to the hydraulic oil supply passage 44a via the accumulator 49a. A second port of the rear brake valve 41a is connected to the tank 48. The third port of the rear brake valve 41a is connected to the rear shuttle valve 47a of the shuttle valve unit 47.

In the first state, the rear brake valve 41a connects the first port and the third port, connects the hydraulic oil supply passage 44a and the rear shuttle valve 47a, and supplies the hydraulic oil to the rear shuttle valve 47a. In the second state, the rear brake valve 41a closes all the ports. In the third state, the rear brake valve 41a connects the second port and the third port, and discharges the hydraulic oil between the rear shuttle valve 47a and the rear brake valve 41a to the tank 48. In the second state and the third state, the rear brake valve 41a stops the supply of the hydraulic oil to the rear shuttle valve 47a.

The first port of the front brake valve 41b is connected to the hydraulic oil supply passage 44b via the accumulator 49b. The second port of the front brake valve 41b is connected to the tank 48. The third port of the front brake valve 41b is connected to the front shuttle valve 47b of the shuttle valve unit 47.

In the first state, the front brake valve 41b connects the first port and the third port, connects the hydraulic oil supply passage 44b and the front shuttle valve 47b, and supplies the hydraulic oil to the front shuttle valve 47b. The front brake valve 41b closes all the ports in the second state. In the third state, the front brake valve 41b connects the second port and the third port, and discharges the hydraulic oil between the front shuttle valve 47b and the front brake valve 41b to the tank 48. The front brake valve 41b stops the supply of the hydraulic oil to the front shuttle valve 47b in the second state and the third state.

The opening degrees of the rear brake valve 41a and the front brake valve 41b are adjusted in accordance with the operation amount of the brake pedal 54, and the amount of hydraulic oil supplied to the shuttle valve unit 47 is changed. For example, when the operation amount of the brake pedal 54 is large, the amount of the hydraulic oil supplied from the rear brake valve 41a and the front brake valve 41b to the shuttle valve unit 47 increases.

The brake circuit 42a is provided on the rear axle 34 (FIG. 2). The brake circuit 42a is connected to the rear shuttle valve 47a. The brake circuit 42b is provided on the front axle 34 (FIG. 2). The brake circuit 42b is connected to the front shuttle valve 47b.

The brake circuits 42a and 42b are hydraulic brakes. The braking force of the brake circuit 42a increases as the amount or pressure of the hydraulic oil supplied from the rear shuttle valve 47a increases. The braking force of the brake circuit 42b increases as the amount or pressure of the hydraulic oil supplied from the front shuttle valve 47b increases.

The shut-off valve 45 is connected to the hydraulic oil supply passage 44b. The shut-off valve 45 is a solenoid valve having four ports and taking two states of an open state and a closed state. A first port of the shut-off valve 45 is connected to the hydraulic oil supply passage 44b. A second port of the shut-off valve 45 is connected to the tank 48. A third port of the shut-off valve 45 is connected to the EPC valve 46. A fourth port of the shut-off valve 45 allows air to pass therethrough in an open state, and is blocked in a closed state.

The shut-off valve 45 is opened and closed based on an instruction from the controller 26. Specifically, the shut-off valve 45 enters an open state when energized by an open command from the controller 26, and enters a closed state when de-energized by a close command from the controller 26.

In the open state, the shut-off valve 45 connects the first port and the third port, and supplies the hydraulic oil from the hydraulic oil supply passage 44b to the EPC valve 46. Further, in the open state, the shut-off valve 45 connects the fourth port through which air passes and the second port connected to the tank 48.

In the closed state, the shut-off valve 45 connects the second port and the third port, and discharges the hydraulic oil between the shut-off valve 45 and the EPC valve 46 to the tank 48. In the closed state, the shut-off valve 45 closes the first port and the fourth port. Thus, in the closed state, the shut-off valve 45 stops the supply of the hydraulic oil from the hydraulic oil supply passage 44b to the EPC valve 46.

In the present embodiment, the controller 26 brings the shut-off valve 45 into the open state only when the vehicle body 1 is traveling backward, for example. The backward movement of the vehicle body 1 is determined by the controller 26 based on the signal indicating the lever position in a traveling direction switching device 53 and the opening degree signal indicating the accelerator operation amount of an accelerator 55.

The EPC valve 46 is disposed in a flow path connecting the shut-off valve 45 and the shuttle valve unit 47. The EPC valve 46 is a solenoid valve having three ports. A first port of the EPC valve 46 is connected to the shut-off valve 45. A second port of the EPC valve 46 is connected to the tank 48. A third port of the EPC valve 46 is connected to the shuttle valve unit 47.

In the open state, the EPC valve 46 connects the first port and the third port and supplies the hydraulic oil supplied from the shut-off valve 45 to the shuttle valve unit 47. The opening degree of the EPC valve 46 is adjusted based on an instruction from the controller 26. By adjusting the opening degree of the EPC valve 46, the amount of hydraulic oil supplied to the shuttle valve unit 47 is changed.

When the EPC valve 46 is in the closed state, the first port is closed, the second port and the third port are connected, and the hydraulic oil in the flow path from the EPC valve 46 to the shuttle valve unit 47 is discharged to the tank 48. Accordingly, in the closed state, the EPC valve 46 stops the supply of the hydraulic oil from the shut-off valve 45 to the shuttle valve unit 47.

In the present embodiment, the controller 26 controls the EPC valve 46 to the open state when the wheel loader 100 travels in a predetermined direction (for example, the rearward direction Zb) and it is determined that the risk of collision with an object in the traveling direction is high.

The shuttle valve unit 47 includes the rear shuttle valve 47a and the front shuttle valve 47b. The rear shuttle valve 47a supplies, to the brake circuit 42a, the hydraulic oil having a higher pressure between the hydraulic oil supplied via the rear brake valve 41a and the hydraulic oil supplied via the EPC valve 46. The front shuttle valve 47b supplies, to the brake circuit 42b, the hydraulic oil having a higher pressure between the hydraulic oil supplied via the front brake valve 41b and the hydraulic oil supplied via the EPC valve 46.

With such a configuration, even when the brake pedal 54 is not operated and the hydraulic oil is not supplied from the brake valve unit 41, the hydraulic oil is supplied from the rear shuttle valve 47a and the front shuttle valve 47b to the brake circuits 42a and 42b and the automatic braking control is performed when the shut-off valve 45 and the EPC valve 46 are opened by the instruction from the controller 26.

The brake that is switched between the braking state and the non-braking state by the brake circuits 42a and 42b is, for example, a wet multi-plate disc brake. The wet multi-plate disc brake mainly includes a plurality of discs, a plate, a piston, and a spring. Each of the plurality of discs is integrated with an output shaft to the front tire 4 or the rear tire 7. The plates alternate with the discs and are attached to a fixed member and do not rotate. The piston is operated by the oil pressure of the hydraulic oil supplied to the brake circuits 42a and 42b. When the piston is operated, the plate is sandwiched and pressed between the plurality of discs. As a result, the wet multi-plate disc brake is operated to be in a braking state. When the supply of the hydraulic oil to the brake circuits 42a and 42b is stopped, the piston is returned to the original position by the repulsive force (restoring force) of the spring, and the pressed state between the plate and the disc is released. As a result, the wet multi-plate disc brake is brought into a non-braking state.

As illustrated in FIG. 2, the parking brake 43 is provided in the transfer 33. As the parking brake 43, for example, a wet multi-stage brake capable of switching between a braking state and a non-braking state, a disc brake, or the like can be used.

### Operation Device 23

The operation device 23 is operated by an operator in the cab 5 (FIG. 1). The operation device 23 includes a work implement operation unit 51, a steering operation unit 52, the traveling direction switching device 53, the brake pedal 54, the accelerator 55, and a parking switch 56.

The work implement operation unit 51 is provided in the cab 5. The work implement operation unit 51 operates an operation of the work implement 3, and is, for example, an operation lever operated by an operator. The operation amount of the work implement operation unit 51 is detected by, for example, a potentiometer, a Hall IC (Integrated Circuit), or the like. When the work implement operation unit 51 is operated, an operation signal indicating an operation amount of the work implement operation unit 51 is transmitted to the controller 26. The controller 26 transmits the operation signal as an operation command to the EPC valve 62 for the work implement cylinders 16 and 17.

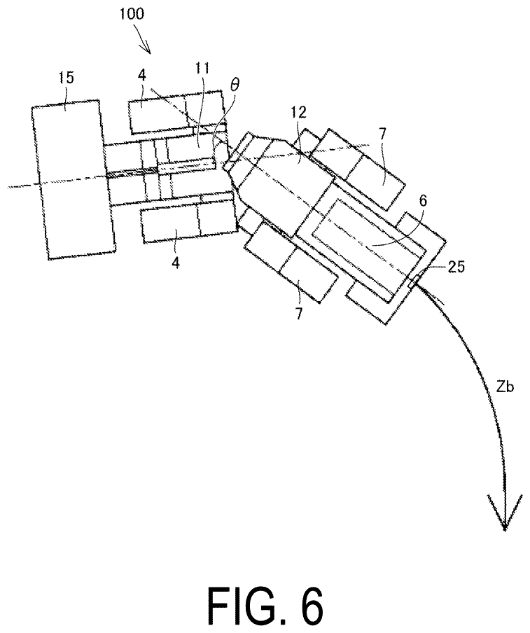

The steering operation unit 52 is provided in the cab 5. The steering operation unit 52 includes a steering wheel, a joystick lever, and the like, and changes a swing angle θ (articulation angle: FIG. 6) of the rear frame 12 with respect to the front frame 11. The operation amount of the steering operation unit 52 is detected by, for example, a potentiometer, a Hall IC, or the like. When the steering operation unit 52 is operated, a steering operation angle is transmitted to the controller 26. The controller 26 sets the steering operation angle to the speed or the target angle of the steering cylinder 9, and transmits the steering operation angle as a swing operation command to the EPC valve 63 for the steering cylinder 9.

The traveling direction switching device 53 is provided in the cab 5. The operator operates the traveling direction switching device 53 to set the traveling direction of the wheel loader 100. The traveling direction switching device 53 is, for example, an FNR lever. The FNR lever 53 can take a lever position of forward (F), neutral (N), or reverse (R). An operation signal indicating the lever position of the FNR lever 53 is transmitted to the controller 26, and the controller 26 switches the traveling direction to forward, neutral, or reverse by controlling the solenoid 32d.

As a position detection sensor that detects the lever position of the FNR lever 53, a potentiometer may be used, or a switch may be provided for each of the forward drive position, the reverse drive position, and the neutral position. Further, both the potentiometer and the switch may be provided so as to be able to detect an erroneous operation even if one of the potentiometer and the switch is erroneously operated.

The brake pedal 54 is provided in the cab 5. The brake pedal 54 adjusts the opening degrees of the rear brake valve 41a and the front brake valve 41b of the brake valve unit 41.

The accelerator 55 is provided in the cab 5. The operator operates the accelerator 55 to set the throttle opening degree. The accelerator 55 generates an opening degree signal indicating an accelerator operation amount and transmits the opening degree signal to the controller 26. The controller 26 controls the rotational speed of the engine 31 based on the transmitted signal.

The parking switch 56 is provided in the cab 5, is a switch whose state can be switched between on and off, and transmits a signal indicating the state to the controller 26. The controller 26 puts the parking brake 43 into a braking state or a non-braking state based on the transmitted signal.

### Detection Device 25

The detection device 25 includes an object sensor 25a, a work implement posture sensor 25b, and a swing angle sensor 25c.

The object sensor 25a detects factors (braking factors) requiring braking, such as an object (obstacle) and a situation (including terrain such as a cliff) around the vehicle body 1. The object sensor 25a detects factors requiring braking, such as an object and a situation (including terrain such as a cliff) located in the traveling direction of the wheel loader 100. To be specific, the object sensor 25a is a rear detection unit that detects a factor requiring braking located in the rearward direction Zb of the vehicle body 1 when the wheel loader 100 travels in the rearward direction Zb. In addition, the object sensor 25a is a front detection unit that is located in the frontward direction Zf of the vehicle body 1 and detects a factor requiring braking when the wheel loader 100 travels in the frontward direction Zf.

When the object sensor 25a is a rear detection unit, the rear detection unit 25a is attached to, for example, the rear end of the vehicle body 1 as illustrated in FIG. 1, but may be attached to a position other than the rear end. When the object sensor 25a is the front detection unit, the front detection unit 25a may be attached to, for example, the cab 5, may be attached to the front frame 11, or may be attached to other components.

The object sensor 25a is, for example, a LiDAR (Light Detection and Ranging) that emits laser light to acquire information on an object. The object sensor 25a may be a Radar (Radio Detection and Ranging) that acquires information on a target object by emitting radio waves. The radar may be, for example, a millimeter-wave radar that uses a reception antenna to detect a state in which a radio wave in a millimeter-wave band emitted from a transmission antenna is reflected by a surface of an object and returns. The object sensor 25a may be a visual sensor including a camera. The object sensor 25a may be an infrared sensor.

Information detected by the object sensor 25a is transmitted to the controller 26, and the controller 26 determines whether there is a braking factor (a factor requiring braking) in the traveling direction of the vehicle body 1. Further, the controller 26 calculates a distance to the detected braking factor. The controller 26 may determine whether a risk (reach risk) of the vehicle body 1 reaching (for example, colliding with) the braking factor is high based on a distance to the detected braking factor.

The work implement posture sensor 25b is a sensor that detects the posture of the work implement 3. The work implement posture sensor 25b has, for example, a boom angle sensor and a bucket angle sensor.

The boom angle sensor includes, for example, a rotary encoder provided on a boom pin that is an attachment portion of boom 14 to the traveling body 2. The boom angle sensor detects an angle of the boom 14 with respect to the horizontal direction and generates a signal of the detected angle of the boom 14. The boom angle sensor outputs a signal of the angle of the boom 14 to the controller 26.

The bucket angle sensor is constituted by, for example, a rotary encoder provided on a support pin that is a rotation shaft of the bell crank 18. The bucket angle sensor detects an angle of the bucket 15 with respect to the boom 14, and generates a signal of the detected angle of the bucket 15. The bucket angle sensor outputs a signal of the angle of the bucket 15 to the controller 26.

Instead of or in addition to the boom angle sensor and the bucket angle sensor, the work implement posture sensor 25b may be an angle sensor that detects the angle of the bell crank 18 and an angle sensor that detects the angle of the link. The work implement posture sensor 25b is not limited to the rotary encoder described above, and may be a stroke sensor, an IMU (Inertial Measurement Unit), a potentiometer, a visual sensor, or the like.

The swing angle sensor 25c detects a swing angle θ, which is an angle formed by the front frame 11 and the rear frame 12, and generates a signal of the detected swing angle θ. The swing angle sensor 25c outputs a signal of the swing angle θ to the controller 26.

The swing angle sensor 25c is attached to, for example, the steering cylinder 9. The swing angle sensor 25c is, for example, a potentiometer and directly detects the swing angle θ. Further, the swing angle sensor 25c may detect a stroke length of the steering cylinder 9. The controller 26 may calculate the swing angle θ from the stroke length of the steering cylinder 9.

### Operation Unit 24

The operation unit 24 includes the steering cylinder 9, the work implement cylinders 16 and 17, the EPC valves 62 and 63, and a hydraulic pump 61. A part of the driving force of the engine 31 is transmitted to the hydraulic pump 61. The hydraulic pump 61 is driven by the engine, and operates the work implement cylinders 16 and 17 and the steering cylinder 9 by the discharged hydraulic oil. The hydraulic oil discharged from the hydraulic pump 61 is supplied to the work implement cylinders 16 and 17 and the steering cylinder 9 via the EPC valves 62 and 63.

Each of the EPC valves 62 and 63 is opened and closed based on an instruction from the controller 26. Specifically, each of the EPC valves 62 and 63 enters an open state when energized by an open command from the controller 26, and enters a closed state when de-energized by a close command from the controller 26.

In the open state, the EPC valve 62 connects the hydraulic pump 61 and the work implement cylinders 16 and 17, and supplies hydraulic oil from the hydraulic pump 61 to the work implement cylinders 16 and 17. In the closed state, the EPC valve 62 stops the supply of the hydraulic oil from the hydraulic pump 61 to the work implement cylinders 16 and 17.

In the open state, the EPC valve 63 connects the hydraulic pump 61 and the steering cylinder 9, and supplies the hydraulic oil from the hydraulic pump 61 to the steering cylinder 9. In the closed state, the EPC valve 62 stops the supply of the hydraulic oil from the hydraulic pump 61 to the steering cylinder 9.

### Controller 26

The controller 26 includes a processor, a main memory, and a storage. The processor is, for example, a CPU (Central Processing Unit). The main memory includes, for example, a nonvolatile memory such as a ROM (Read Only Memory) and a volatile memory such as a RAM (Random Access Memory).

Each of the controller 26 and the operation device 23 may be mounted on the wheel loader 100, or may be disposed outside and away from the wheel loader 100. When each of the controller 26 and the operation device 23 is disposed outside and away from wheel loader 100, each of the controller 26 and the operation device 23 may be wirelessly connected to the drive device 21, the braking device 22, the operation device 23, the object sensor 25a, and the like. The controller 26 may be stored in a server remote from the wheel loader 100. In addition, since the operation device 23 is separated from the wheel loader 100, the operator may remotely operate wheel loader 100 without getting in the cab 5 of the wheel loader 100.

The controller 26 reads a program stored in the storage, expands the program in the main memory, and executes a predetermined process according to the program. The controller 26 may be divided into a collision detection controller and an HST controller. The collision detection controller and the HST controller may have different CPUs. Alternatively, the program may be distributed to the controller 26 via a network.

As illustrated in FIG. 4, the controller 26 includes an automatic braking control unit 27, a work implement posture information acquisition unit 26A, a posture determination unit 26B, a swing angle information acquisition unit 26C, a swing angle determination unit 26D, and a storage unit 26E. The automatic braking control unit 27 includes a traveling direction information acquisition unit 27A, a traveling direction determination unit 27B, an object information acquisition unit 27C, an object determination unit 27D, and an EPC valve control unit 27E.

The state (ON state) in which the automatic braking control is started means a state in which the controller 26 can automatically control the opening and closing operation of the EPC valve 46 based on the detection result of the traveling direction switching device 53 and the detection result of the object sensor 25a.

When the automatic braking control unit 27 starts the automatic braking control, the traveling direction information acquisition unit 27A acquires the switching signal of the traveling direction switching device 53. The traveling direction information acquisition unit 27A outputs the acquired switching signal of the traveling direction switching device 53 to the traveling direction determination unit 27B.

When acquiring the switching signal of the traveling direction switching device 53, the traveling direction determination unit 27B determines whether the traveling direction of the wheel loader 100 is a predetermined direction (for example, the rearward direction Zb) based on the switching signal of the traveling direction switching device 53. The traveling direction determination unit 27B outputs the determination result to the EPC valve control unit 27E.

Even in a stopped state in which the wheels 4 and 7 are not rotating, when the lever position of the traveling direction switching device 53 is in a predetermined direction (for example, the rearward direction Zb), the traveling direction determination unit 27B may determine that the vehicle body 1 is traveling in the predetermined direction (backward traveling state).

When the automatic braking control unit 27 starts the automatic braking control, the object information acquisition unit 27C acquires the detection result of the object sensor 25a. The object information acquisition unit 27C outputs the acquired detection result of the object sensor 25a to the object determination unit 27D. The object determination unit 27D determines whether a risk (reach risk) of the vehicle body 1 reaching a braking factor (for example, colliding with an object) is high based on a detection result of the object sensor 25a, and outputs a determination result to the EPC valve control unit 27E.

The EPC valve control unit 27E controls the opening and closing operation of the EPC valve 46 based on the determination result of the traveling direction determination unit 27B and the determination result of the object determination unit 27D during the execution of the automatic braking control. To be specific, during the execution of the automatic braking control, when the EPC valve control unit 27E acquires, for example, the determination result by the traveling direction determination unit 27B that the traveling direction is the rearward direction Zb and the determination result by the object determination unit 27D that the risk of the vehicle body 1 reaching the braking factor is high, the EPC valve control unit 27E outputs an open command (command current) to the EPC valve 46 so that the EPC valve 46 is brought into the open state. The solenoid of the EPC valve 46 is operated based on the command current, so that the EPC valve 46 is opened. When the EPC valve 46 is opened, the hydraulic oil is supplied from the rear shuttle valve 47a and the front shuttle valve 47b to the brake circuits 42a and 42b, and the braking operation is executed.

The state in which the braking operation is executed (ON state) means a state in which the braking force by the brake circuits 42a and 42b is acting. An example of the case where a braking operation is being performed means that, when the brake is a wet multi-plate disc brake, a plate is sandwiched and pressed between a plurality of discs. On the other hand, a state where the braking operation is not executed (OFF state) means a state where the braking force by the brake circuits 42a and 42b does not act. An example of the case where the braking operation is not performed means that a plate is not pressed between a plurality of discs when the brake is a wet multi-plate disc brake.

The opening degree of the EPC valve 46 is adjusted by a command current output from the EPC valve control unit 27E to the EPC valve 46. In this example, the command current is set to a predetermined value in advance. The command current may be adjusted based on the distance to the detected braking factor. For example, the EPC valve control unit 27E may calculate a deceleration for stopping before the braking factor from the detected distances to the braking factor, and may transmit an open command (command current) to the EPC valve 46 so as to have an opening degree at which the deceleration is exhibited.

As described above, the controller 26 executes the automatic braking control for automatically braking traveling (stopping or decelerating traveling) based on the detection result of the braking factor in the traveling direction. In the automatic braking control, the controller 26 automatically controls the traveling by the braking device 22 based on the detection result of the braking factor by the object sensor 25a. As a result, even when the brake pedal 54 is not operated by the operator, the automatic braking control is executed and the braking force is exerted, and the vehicle body 1 can be stopped before the braking factor.

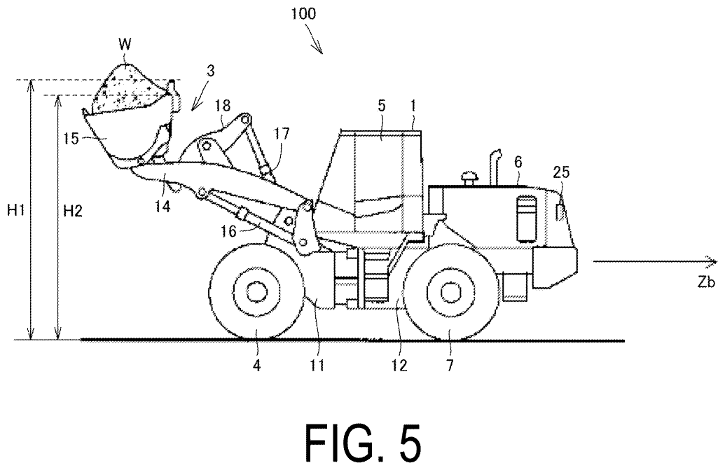

During the execution of the automatic braking control, the controller 26 restricts at least one of the lifting operation of the work implement 3 and the operation of increasing the swing angle θ. To be specific, the controller 26 restricts the lifting operation of the work implement 3 so that the lifting of the work implement 3 is within a restriction height H1 (FIG. 5) based on the posture detection of the work implement 3. When the height of the work implement 3 reaches the restriction height H1 (FIG. 5) equal to or lower than a predetermined height H2, the controller 26 stops or decelerates the lifting operation of the work implement 3 without receiving an operation command from the operator to lift the work implement 3 above the predetermined height H2.

In addition, the controller 26 restricts the operation of increasing the swing angle θ of the rear frame 12 with respect to the front frame 11 so that the swing angle θ (FIG. 6) is within the restriction angle. When the swing angle θ becomes a predetermined angle smaller than the restriction angle, the controller 26 stops or decelerates the operation of increasing the swing angle θ of the rear frame 12 with respect to the front frame 11 without receiving the operation command from the operator to increase the swing angle θ from the predetermined angle.

The work implement posture information acquisition unit 26A acquires a signal related to work implement posture information from the work implement operation unit 51 or the work implement posture sensor 25b. The work implement posture information acquisition unit 26A outputs a signal related to the acquired work implement posture information to the posture determination unit 26B. The posture determination unit 26B calculates the height of the work implement 3 based on the work implement posture information. When calculating the height of the work implement 3, the posture determination unit 26B refers to the dimensions and the like of each part of the work implement 3 stored in advance in the storage unit 26E. The posture determination unit 26B determines whether the calculated height of the work implement 3 has reached a predetermined height H2. When making this determination, the posture determination unit 26B refers to the predetermined height H2 stored in advance in the storage unit 26E.

When posture determination unit 26B determines that the height of the work implement 3 has reached the predetermined height H2, the posture determination unit 26B outputs, to the EPC valve control unit 27E, a restriction command to restrict the lifting operation of the work implement 3. To be more specific, when the posture determination unit 26B determines that the height of the work implement 3 has reached the predetermined height H2, the posture determination unit 26B outputs, to the EPC valve control unit 27E, a restriction command to stop or decelerate the lifting operation of the work implement 3.

When the EPC valve control unit 27E acquires the restriction command from the posture determination unit 26B, the EPC valve control unit 27E outputs a command current value to the EPC valve 62 based on the restriction command. When the EPC valve control unit 27E acquires, from the posture determination unit 26B, the restriction command to stop the lifting operation of the work implement 3, the EPC valve control unit 27E controls the EPC valve 62 to be in the closed state. To be more specific, the EPC valve control unit 27E outputs a command current to the EPC valve 62 so as to close the EPC valve 62. However, when the EPC valve 62 does not enter the open state and maintains the closed state unless the command current value of the open command is input, the EPC valve control unit 27E does not have to output the command current value to the EPC valve 62. Further, when the EPC valve control unit 27E acquires, from the posture determination unit 26B, a restriction command to decelerate the lifting operation of the work implement 3, the EPC valve control unit 27E controls the EPC valve 62 so as to decrease the opening degree of the EPC valve 62.

As described above, during the execution of the automatic braking control, the lifting operation of the work implement 3 is restricted so that the height of the work implement 3 is within the restriction height H1 based on the posture detection of the work implement 3.

The swing angle information acquisition unit 26C acquires a signal related to swing angle information from the steering operation unit 52 or the swing angle sensor 25c. The swing angle information acquisition unit 26C outputs a signal related to the acquired swing angle information to the swing angle determination unit 26D. The swing angle determination unit 26D calculates the swing angle θ based on the swing angle information. The swing angle determination unit 26D determines whether the calculated swing angle θ has reached a predetermined angle. When making this determination, the swing angle determination unit 26D refers to a predetermined angle stored in advance in the storage unit 26E.

When the swing angle determination unit 26D determines that the swing angle θ has reached the predetermined angle, the swing angle determination unit 26D outputs, to the EPC valve control unit 27E, a restriction command for restricting an operation of increasing the swing angle θ of the rear frame 12 with respect to the front frame 11. To be specific, when the swing angle determination unit 26D determines that the swing angle θ has reached the predetermined angle, the swing angle determination unit 26D outputs, to the EPC valve control unit 27E, a restriction command to stop or decelerate the operation of increasing the swing angle θ of the rear frame 12 with respect to the front frame 11.

When the EPC valve control unit 27E receives the restriction command from the swing angle determination unit 26D, the EPC valve control unit 27E outputs a command current value to the EPC valve 63 based on the restriction command. When the EPC valve control unit 27E acquires, from the swing angle determination unit 26D, the restriction command to stop the operation of increasing the swing angle θ, the EPC valve control unit 27E controls the EPC valve 63 to be in the closed state. To be more specific, the EPC valve control unit 27E outputs a command current to the EPC valve 63 so as to close the EPC valve 63. However, when the EPC valve 63 does not enter the open state and maintains the closed state unless the command current value of the open command is input, the EPC valve control unit 27E does not have to output the command current value to the EPC valve 63. Further, when the EPC valve control unit 27E acquires, from the swing angle determination unit 26D, the restriction command to decelerate the operation of increasing the swing angle θ, the EPC valve control unit 27E controls the EPC valve 63 so as to decrease the opening degree of the EPC valve 63.

As described above, during the execution of the automatic braking control, the operation of increasing the swing angle θ of the rear frame 12 with respect to the front frame 11 is restricted so that the swing angle θ is within the restriction angle.

### Control Method for Wheel Loader 100

Next, a control method for the wheel loader 100 according to the present embodiment will be described with reference to FIGS. 4, 7, and 8.

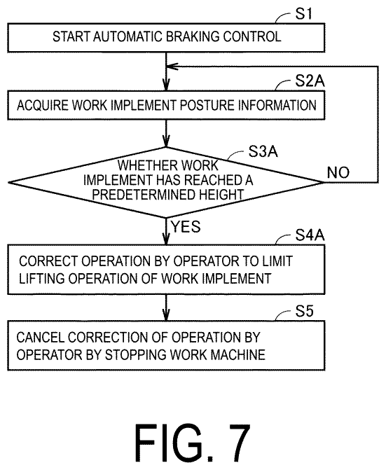

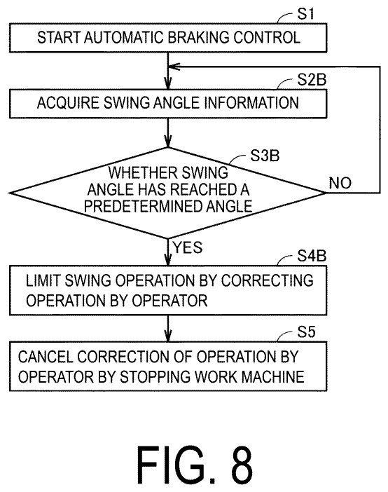

FIGS. 7 and 8 are a first flowchart and a second flowchart, respectively, illustrating a control method for a wheel loader according to an embodiment of the present disclosure. First, a method for controlling the height of the work implement 3 to be within the restriction height H1 during the execution of the automatic braking control will be described.

As illustrated in FIGS. 4 and 7, the automatic braking control is started by the operation by the operator (step S1: FIG. 7). The start operation of the automatic braking control by the operator is, for example, an operation of inserting a key into a key switch of the wheel loader 100 to switch the wheel loader 100 from the OFF state to the ON state. Accordingly, when the automatic braking control unit 27 acquires the start information of the automatic braking control, the automatic braking control unit 27 starts the automatic braking control.

When the automatic braking control is started, the automatic braking control unit 27 outputs a start signal of the automatic braking control to the work implement posture information acquisition unit 26A. When the work implement posture information acquisition unit 26A acquires the start signal, the work implement posture information acquisition unit 26A acquires a signal relating to the work implement posture information from the work implement operation unit 51 or the work implement posture sensor 25b (step S2A: FIG. 7).

The work implement posture information acquisition unit 26A outputs a signal related to the acquired work implement posture information to the posture determination unit 26B. The posture determination unit 26B calculates the height of the work implement 3 based on the work implement posture information. When calculating the height of the work implement 3, the posture determination unit 26B refers to the dimensions and the like of each part of the work implement 3 stored in advance in the storage unit 26E. The posture determination unit 26B determines whether the calculated height of the work implement 3 has reached a predetermined height H2 (step S3A: FIG. 7). When making this determination, the posture determination unit 26B refers to the predetermined height H2 stored in advance in the storage unit 26E.

When the posture determination unit 26B determines that the height of the work implement 3 has not reached the predetermined height H2, step S2A of acquiring the work implement posture information and step S3A of determining whether the calculated height of the work implement 3 has reached the predetermined height H2 are repeated.

On the other hand, when posture determination unit 26B determines that the height of the work implement 3 has reached the predetermined height H2, the posture determination unit 26B outputs, to the EPC valve control unit 27E, a restriction command to restrict the lifting operation of the work implement 3. To be more specific, when the posture determination unit 26B determines that the height of the work implement 3 has reached the predetermined height H2, the posture determination unit 26B outputs, to the EPC valve control unit 27E, a restriction command to stop or decelerate the lifting operation of the work implement 3.

When the EPC valve control unit 27E acquires the restriction command from the posture determination unit 26B, the EPC valve control unit 27E controls the EPC valve 62 based on the restriction command. When the EPC valve control unit 27E acquires, from the posture determination unit 26B, the restriction command to stop the lifting operation of the work implement 3, the EPC valve control unit 27E controls the EPC valve 62 to be in the closed state. Further, when the EPC valve control unit 27E acquires, from the posture determination unit 26B, a restriction command to decelerate the lifting operation of the work implement 3, the EPC valve control unit 27E controls the EPC valve 62 so as to decrease the opening degree of the EPC valve 62.

As described above, during the execution of the automatic braking control, the controller 26 corrects the operation by the operator to restrict the lifting operation of the work implement 3 (step S4A: FIG. 7). That is, when the height of the work implement 3 reaches the predetermined height H2, the controller 26 stops or decelerates the lifting operation of the work implement 3 without receiving the operation command from the operator to lift the work implement 3 above the predetermined height. Accordingly, the height of the work implement 3 is controlled to be within the restriction height H1 during execution of the automatic braking control.

Thereafter, the correction of the operation by the operator is canceled by stopping the wheel loader 100 (step S5: FIG. 7). The stop of wheel loader 100 is, for example, an operation of a key switch.

Next, a method for controlling the swing angle θ to be within the restriction angle during the execution of the automatic braking control will be described.

As illustrated in FIGS. 4 and 8, the automatic braking control is started by the operation by the operator (step S1: FIG. 8). The start operation of the automatic braking control by the operator is, for example, an operation of inserting a key into a key switch of the wheel loader 100 to switch the wheel loader 100 from the OFF state to the ON state. Accordingly, when the automatic braking control unit 27 acquires the start information of the automatic braking control, the automatic braking control unit 27 starts the automatic braking control.

When the automatic braking control is started, the automatic braking control unit 27 outputs a start signal of the automatic braking control to the swing angle information acquisition unit 26C. When acquiring the start signal, the swing angle information acquisition unit 26C acquires a signal related to the swing angle information from the steering operation unit 52 or the swing angle sensor 25c (step S2B: FIG. 8).

The swing angle information acquisition unit 26C outputs a signal related to the acquired swing angle information to the swing angle determination unit 26D. The swing angle determination unit 26D calculates the swing angle θ based on the swing angle information. The swing angle determination unit 26D determines whether the calculated swing angle θ has reached a predetermined angle (step S3B: FIG. 8). When making this determination, the swing angle determination unit 26D refers to a predetermined angle stored in advance in the storage unit 26E.

When the swing angle determination unit 26D determines that the swing angle θ has not reached the predetermined angle, step S2B of acquiring the swing angle information and step S3B of determining whether the calculated swing angle θ has reached the predetermined angle are repeated.

On the other hand, when the swing angle determination unit 26D determines that the swing angle θ reaches the predetermined angle, the swing angle determination unit 26D outputs a restriction command to restrict the swing angle θ to the EPC valve control unit 27E. To be specific, when the swing angle determination unit 26D determines that the swing angle θ has reached the predetermined angle, the swing angle determination unit 26D outputs, to the EPC valve control unit 27E, a restriction command to stop or decelerate the operation of increasing the swing angle θ of the rear frame 12 with respect to the front frame 11.

When the EPC valve control unit 27E acquires the restriction command from the swing angle determination unit 26D, the EPC valve control unit 27E controls the EPC valve 63 based on the restriction command. When the EPC valve control unit 27E acquires, from the swing angle determination unit 26D, the restriction command to stop the operation of increasing the swing angle θ, the EPC valve control unit 27E controls the EPC valve 63 to be in the closed state. Further, when the EPC valve control unit 27E acquires, from the swing angle determination unit 26D, the restriction command to decelerate the operation of increasing the swing angle θ, the EPC valve control unit 27E controls the EPC valve 63 so as to decrease the opening degree of the EPC valve 63.

As described above, during the execution of the automatic braking control, the controller 26 corrects the operation by the operator to restrict the operation of increasing the swing angle θ of the rear frame 12 with respect to the front frame 11 (step S4B: FIG. 8). That is, when the swing angle θ reaches the predetermined angle, the controller 26 stops or decelerates the operation of increasing the swing angle θ of the rear frame 12 with respect to the front frame 11 without receiving the operation command from the operator to increase the swing angle θ from the predetermined angle. As a result, the swing angle θ is controlled to be within the restriction angle during execution of the automatic braking control.

Thereafter, the correction of the operation by the operator is canceled by stopping the wheel loader 100 (step S5: FIG. 8). The stop of wheel loader 100 is, for example, an operation of a key switch. The wheel loader 100 may be stopped, for example, when the vehicle speed of the wheel loader 100 is 0 (zero).

In the control method illustrated in each of FIGS. 7 and 8, the automatic braking control is performed as follows.

As illustrated in FIG. 4, when the automatic braking control is started, the traveling direction information acquisition unit 27A acquires the switching signal of the traveling direction switching device 53. The traveling direction information acquisition unit 27A outputs the acquired switching signal of the traveling direction switching device 53 to the traveling direction determination unit 27B.

When acquiring the switching signal of the traveling direction switching device 53, the traveling direction determination unit 27B determines whether the traveling direction of the wheel loader 100 is a predetermined direction (for example, the rearward direction Zb) based on the switching signal of the traveling direction switching device 53. The traveling direction determination unit 27B outputs the determination result to the EPC valve control unit 27E.

When the automatic braking control unit 27 starts the automatic braking control, the object information acquisition unit 27C acquires the detection result of the object sensor 25a. The object information acquisition unit 27C outputs the acquired detection result of the object sensor 25a to the object determination unit 27D. The object determination unit 27D determines whether the risk of the vehicle body 1 reaching the braking factor is high based on the detection result of the object sensor 25a and the like, and outputs the determination result to the EPC valve control unit 27E.

The EPC valve control unit 27E controls the opening and closing operation of the EPC valve 46 based on the determination result of the traveling direction determination unit 27B and the determination result of the object determination unit 27D during the execution of the automatic braking control. To be specific, during the execution of the automatic braking control, when the EPC valve control unit 27E acquires, for example, the determination result by the traveling direction determination unit 27B that the traveling direction is the rearward direction Zb and the determination result by the object determination unit 27D that the risk of the vehicle body 1 reaching the braking factor is high, the EPC valve control unit 27E outputs an open command (command current) to the EPC valve 46 so that the EPC valve 46 is brought into the open state. The solenoid of the EPC valve 46 is operated based on the command current, so that the EPC valve 46 is opened. When the EPC valve 46 is opened, the hydraulic oil is supplied from the rear shuttle valve 47a and the front shuttle valve 47b to the brake circuits 42a and 42b, and the braking operation is executed.

### Effects

Next, effects of the present embodiment will be described.

During work at a construction site, a work machine such as the wheel loader 100 often assumes an unstable posture. In such an unstable posture, when sudden braking is performed by the automatic braking control, the posture of the wheel loader 100 becomes more unstable. In particular, when the work implement 3 of the wheel loader 100 is at a lifted position in a loaded state, the position of the center of gravity of the wheel loader 100 becomes high, so that the wheel loader 100 becomes more unstable.

In contrast, in the present disclosure, as illustrated in FIGS. 4 and 7, the controller 26 restricts the lifting operation of the work implement 3 during the execution of the automatic braking control. Therefore, the wheel loader 100 is prevented from being in an unstable state during execution of the automatic braking control, and a stable state can be maintained.

Further, as illustrated in FIGS. 4 and 7, in the automatic braking control, the controller 26 restricts the lifting operation of the work implement 3 so that the lifting of the work implement 3 is within the restriction height H1 based on the posture detection of the work implement 3. Thus, the wheel loader 100 can be maintained in a stable state even during the execution of the automatic braking control. In the automatic braking control, the controller 26 may completely prohibit the operation of the work implement 3.

As illustrated in FIGS. 4 and 7, when the height of the work implement 3 reaches the predetermined height H2, the controller 26 stops or decelerates the lifting operation of the work implement 3 without receiving an operation command from the operator to lift the work implement 3 above the predetermined height H2. Accordingly, the wheel loader 100 can be maintained in a stable state regardless of the operation by the operator during the execution of the automatic braking control.

Further, as illustrated in FIG. 4, during the execution of the automatic braking control, the controller 26 restricts the lifting operation of the work implement 3 while automatically braking traveling by the braking device 22 based on the determination result of the risk of the wheel loader 100 reaching the braking factor (risk of collision with an obstacle or the like). Thus, the wheel loader 100 can be maintained in a stable state even during the execution of the automatic braking control.

In addition, in an unstable posture in which the rear frame 12 swings with respect to the front frame 11 at the time of work at a construction site, when sudden braking is performed by the automatic braking control, the posture of the wheel loader 100 becomes more unstable.

In contrast, in the present disclosure, as illustrated in FIGS. 4 and 8, the controller 26 restricts an operation of increasing the swing angle θ of the rear frame 12 with respect to the front frame 11 during execution of the automatic braking control. Therefore, the wheel loader 100 is prevented from being in an unstable state during execution of the automatic braking control, and a stable state can be maintained.

Further, as illustrated in FIGS. 4 and 8, the controller 26 restricts the operation of increasing the swing angle θ of the rear frame 12 with respect to the front frame 11 so that the swing angle θ is within the restriction angle. Thus, the wheel loader 100 can be maintained in a stable state even during the execution of the automatic braking control.

Further, as illustrated in FIGS. 4 and 8, when the swing angle θ reaches the predetermined angle, the controller 26 stops or decelerates the operation of increasing the swing angle θ of the rear frame 12 with respect to the front frame 11 without receiving the operation command from the operator to increase the swing angle θ from the predetermined angle. Accordingly, the wheel loader 100 can be maintained in a stable state regardless of the operation by the operator during the execution of the automatic braking control.

Further, as illustrated in FIG. 4, during the execution of the automatic braking control, the controller 26 restricts the operation of increasing the swing angle θ while automatically braking traveling by the braking device 22 based on the determination result of the risk of the wheel loader 100 reaching the braking factor (risk of collision with an obstacle or the like). Thus, the wheel loader 100 can be maintained in a stable state even during the execution of the automatic braking control.

Although the braking operation of the automatic braking control in the case where a braking factor is present in the rearward direction of the vehicle body 1 when the wheel loader 100 moves backward has been described above, the braking operation of the automatic braking control in the present disclosure is similarly applicable to the case where a braking factor is present in the frontward direction of the vehicle body 1 when the wheel loader 100 moves forward. In this case, when the wheel loader 100 is moving forward and the risk of reaching the braking factor in the frontward direction is high, it is determined that the braking command by the automatic braking control is necessary, and the braking operation is executed.

### APPENDICES

The above description includes the following features.

### Appendix 1

A work machine configured to perform automatic braking control for automatically braking traveling, the work machine including: a traveling body; a work implement disposed on the traveling body; and a controller configured to restrict a lifting operation of the work implement during execution of the automatic braking control.

### Appendix 2

The work machine according to Appendix 1, wherein the controller restricts the lifting operation of the work implement so that lifting of the work implement is within a restriction height based on posture detection of the work implement.

### Appendix 3

The work machine according to Appendix 1 or 2, wherein when a height of the work implement reaches a predetermined height, the controller stops or decelerates the lifting operation of the work implement without receiving an operation command from an operator to lift the work implement above the predetermined height.

### Appendix 4

The work machine according to any one of Appendices 1 to 3, further including: an object sensor configured to detect a braking factor located in a traveling direction of the work machine; and a braking device configured to brake traveling, wherein during execution of the automatic braking control, the controller automatically brakes traveling by the braking device based on a determination result of a risk of reaching the braking factor detected by the work machine and the object sensor, and restricts the lifting operation of the work implement.

### Appendix 5

A work machine configured to perform automatic braking control for automatically braking traveling, the work machine including: a front frame; a rear frame swingably coupled to the front frame; and a controller configured to restrict an operation of increasing a swing angle of the rear frame with respect to the front frame during execution of the automatic braking control.

### Appendix 6

The work machine according to Appendix 5, wherein the controller restricts the operation of increasing the swing angle of the rear frame with respect to the front frame so that the swing angle is within a restriction angle.

### Appendix 7

The work machine according to Appendix 5 or 6, wherein when the swing angle reaches a predetermined angle, the controller stops or decelerates the operation of increasing the swing angle of the rear frame with respect to the front frame without receiving an operation command from an operator to increase the swing angle from the predetermined angle.

### Appendix 8

The work machine according to any one of Appendices 5 to 7, further including: an object sensor configured to detect a braking factor located in a traveling direction of the work machine; and a braking device configured to brake traveling, wherein during execution of the automatic braking control, the controller automatically brakes traveling by the braking device based on a determination result of a risk of reaching the braking factor detected by the work machine and the object sensor, and restricts the operation of increasing the swing angle.

### Appendix 9

A braking system for a work machine configured to perform automatic braking control for automatically braking traveling, the braking system including: a traveling body; a work implement disposed on the traveling body; and a controller configured to restrict a lifting operation of the work implement during execution of the automatic braking control.

### Appendix 10

A braking system for a work machine configured to perform automatic braking control for automatically braking traveling, the braking system including: a front frame; a rear frame swingably coupled to the front frame; and a controller configured to restrict an operation of increasing a swing angle of the rear frame with respect to the front frame during execution of the automatic braking control.

### Appendix 11

A control method for a work machine that includes a traveling body and a work implement disposed on the traveling body and is configured to perform automatic braking control for automatically braking traveling, the control method including: starting execution of the automatic braking control; and restricting a lifting operation of the work implement during execution of the automatic braking control.

### Appendix 12

A control method for a work machine that includes a front frame and a rear frame swingably coupled to the front frame and is configured to perform automatic braking control for automatically braking traveling, the control method including: starting execution of the automatic braking control; and restricting an operation of increasing a swing angle of the rear frame with respect to the front frame during execution of the automatic braking control.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1 Vehicle body, 2 Traveling body, 3 Work implement, 4 Front tire, 5 Cab, 5s Operator seat, 6 Engine room, 7 Rear tire, 9 Steering cylinder, 10 Vehicle body frame, 11 Front frame, 12 Rear frame, 13 Coupling shaft portion, 14 Boom, 15 Bucket, 16 Lift cylinder, 17 Bucket cylinder, 18 Bell crank, 21 Drive device, 22 Braking device, 23 Operation device, 24 Operation unit, 25 Detection device, 25a Object sensor, 25b Work implement posture sensor, 25c Swing angle sensor, 26 Controller, 26A Work implement posture information acquisition unit, 26B Posture determination unit, 26C Swing angle information acquisition unit, 26D Swing angle determination unit, 26E Storage unit, 27 Automatic braking control unit, 27A Traveling direction information acquisition unit, 27B Traveling direction determination unit, 27C Object information acquisition unit, 27D Object determination unit, 27E Valve control unit, 31 Engine, 32a Pump, 32b Motor, 32c1 First drive circuit, 32c2 Second drive circuit, 32c Hydraulic circuit, 32d, 32e Solenoid, 33 Transfer, 34 Axle, 40 Braking unit, 41 Brake valve unit, 41a Rear brake valve, 41b Front brake valve, 42a, 42b Brake circuit, 43 Parking brake, 44a, 44b Hydraulic oil supply passage, 45 Shut-off valve, 46, 62, 63 EPC valve, 47 Shuttle valve unit, 47a Rear shuttle valve, 47b Front shuttle valve, 48 Tank, 49a, 49b Accumulator, 51 Work implement operation unit, 52 Steering operation unit, 53 Traveling direction switching device, 54 Brake pedal, 55 Accelerator, 56 Parking switch, 61 Hydraulic pump, 100 Wheel loader

1. A work machine configured to perform automatic braking control for automatically braking traveling, the work machine comprising:
a traveling body;
a work implement disposed on the traveling body; and
a controller configured to restrict a lifting operation of the work implement during execution of the automatic braking control.

2. The work machine according to claim 1, wherein
the controller restricts the lifting operation of the work implement so that lifting of the work implement is within a restriction height based on posture detection of the work implement.

3. The work machine according to claim 1, wherein
when a height of the work implement reaches a predetermined height, the controller stops or decelerates the lifting operation of the work implement without receiving an operation command from an operator to lift the work implement above the predetermined height.

4. The work machine according to claim 1, further comprising:
an object sensor configured to detect a braking factor located in a traveling direction of the work machine; and
a braking device configured to brake traveling, wherein
during execution of the automatic braking control, the controller automatically brakes traveling by the braking device based on a determination result of a risk of reaching the braking factor detected by the work machine and the object sensor, and restricts the lifting operation of the work implement.

5. A work machine configured to perform automatic braking control for automatically braking traveling, the work machine comprising:
a front frame;
a rear frame swingably coupled to the front frame; and
a controller configured to restrict an operation of increasing a swing angle of the rear frame with respect to the front frame during execution of the automatic braking control.

6. The work machine according to claim 5, wherein
the controller restricts the operation of increasing the swing angle of the rear frame with respect to the front frame so that the swing angle is within a restriction angle.

7. The work machine according to claim 5, wherein
when the swing angle reaches a predetermined angle, the controller stops or decelerates the operation of increasing the swing angle of the rear frame with respect to the front frame without receiving an operation command from an operator to increase the swing angle from the predetermined angle.

8. The work machine according to claim 5, further comprising:
an object sensor configured to detect a braking factor located in a traveling direction of the work machine; and
a braking device configured to brake traveling, wherein
during execution of the automatic braking control, the controller automatically brakes traveling by the braking device based on a determination result of a risk of reaching the braking factor detected by the work machine and the object sensor, and restricts the operation of increasing the swing angle.

9. A braking system for a work machine configured to perform automatic braking control for automatically braking traveling, the braking system comprising:
a traveling body;
a work implement disposed on the traveling body; and
a controller configured to restrict a lifting operation of the work implement during execution of the automatic braking control.

10. A braking system for a work machine configured to perform automatic braking control for automatically braking traveling, the braking system comprising:
a front frame;
a rear frame swingably coupled to the front frame; and
a controller configured to restrict an operation of increasing a swing angle of the rear frame with respect to the front frame during execution of the automatic braking control.

11. A control method for a work machine that includes a traveling body and a work implement disposed on the traveling body and is configured to perform automatic braking control for automatically braking traveling, the control method comprising:
starting execution of the automatic braking control; and
restricting a lifting operation of the work implement during execution of the automatic braking control.

12. A control method for a work machine that includes a front frame and a rear frame swingably coupled to the front frame and is configured to perform automatic braking control for automatically braking traveling, the control method comprising:
starting execution of the automatic braking control; and
restricting an operation of increasing a swing angle of the rear frame with respect to the front frame during execution of the automatic braking control.
